(19) United States
(12) Patent Application Publication
(10) Pub. No.: US 2026/0112063 A1
(43) Pub. Date: Apr. 23, 2026

(54) System for Providing a Share Statement Linked to a Digital Identifier of an Image

(71) Applicant: Sasha Aps, Odense C (DK)

(72) Inventor: Thomas Alexander Krause Eriksson, Odense N (DK)

(73) Assignee: Sasha Aps, Odense C (DK)

(21) Appl. No.: 19/427,800

(22) Filed: Dec. 19, 2025

Related U.S. Application Data
(63) Continuation-in-part of application No. 17/857,905, filed on Jul. 5, 2022, now Pat. No. 12,536,311.
(60) Provisional application No. 63/220,173, filed on Jul. 9, 2021.

(51) Int. Cl. G06T 9/00; G06T 1/00; H04L 51/04; H04L 51/10

(52) U.S. Cl. CPC G06T 9/00; G06T 1/0057; H04L 51/04; H04L 51/10

(57) ABSTRACT

A service provider acting in according to an auxiliary information that include a share statement linked to an image. A user has uploaded an image to the service provider. The service provider sends the image to a server system that comprises a registry with a plurality of one or more digital identifier keys linked to auxiliary information including at least a share statement. The server system searches in the image for one or more encoded digital identifiers as a function of the one or more digital identifier keys. When the server system identifies a digital identifier in the image, the server system sends at least the share statement of the image to the service provider so that the service provider may act in accordance with the share statement.

### CLAIM OF PRIORITY

This application is a continuation-in-part of, and claims priority to, U.S. patent application Ser. No. 17/857,905, filed Jul. 5, 2022, invented by Thomas Alexander Krause Eriksson, entitled “Providing a Share Statement Linked to a Digital Identifier of an Image,” the entire contents of which are hereby incorporated by reference for all purposes as if fully set forth herein.

U.S. patent application Ser. No. 17/857,905 claims priority to U.S. Provisional Patent Application Ser. No. 63/220,173, filed Jul. 9, 2021, invented by Thomas Alexander Krause Eriksson, entitled “System for Providing a Share Statement Linked to a Digital Identifier of an Image,” the entire contents of which are hereby incorporated by reference for all purposes as if fully set forth herein.

### FIELD OF THE INVENTION

Embodiments of the invention relate to systems and methods for providing a share statement linked to a digital identifier of an image. Furthermore, embodiments of the invention relate to systems and methods for efficient identification of an image and for global change of the share statement linked to a digital identifier of an image.

### BACKGROUND OF THE INVENTION

There is an ever-increasing number of images and videos available on the Internet. Such images and videos may be hosted by various service providers including but not limited to companies such as Facebook, Snapchat, Alphabet, Twitter, and Reddit.

Often, there are several copies or partial copies of the very same image across service providers, or even at the same service provider. This is not a problem in and of itself as there are many reasons why a person or company may actively choose to have an image or video posted, hosted, or otherwise publicly available at multiple locations on the Internet.

The Internet allows for the easy sharing of images and videos, even for those images and videos which were never intended to be shared in a widespread or public manner. When images and videos are widely shared across the Internet, it is almost impossible to identify the initial actor or actors who were responsible for their distribution. Images and/or videos may be shared over the Internet intentionally, accidentally, or in bad faith, such as when a third party creates a fake profile at a service provider of an influencer in the effort to abuse the good will of the influencer.

Since it is easy to share and distribute images on the Internet, it is hard to enforce the right to be forgotten as recognized and practiced in the European Union. This is partly due the amount of computational power it would require to compare one single image of interest against the ever-growing number of many millions of other images scattered across the Internet.

Accordingly, it is in practically impossible to retract an image from the Internet after it has spread; however, the need exists for preventing or limiting the spreading of images across various Internet service providers, which constitute the chief source from which most users access digital content on the Internet.

### DESCRIPTION OF THE DRAWINGS

FIGS. 1 and 2 are illustrations of a user uploading an image via a sender device to a recipient in accordance with an embodiment of the invention.

FIGS. 3 and 4 are illustrations of a user uploading an image to a service provider in accordance with an embodiment of the invention.

FIG. 5 is a block diagram of a system in accordance with an embodiment of the invention.

FIG. 6 is a block diagram of a service provider requesting a share statement and a sender requesting a change in the share statement in accordance with an embodiment of the invention.

FIG. 7 is an illustration of an owner or user requesting information of the recipient who has leaked a recipient-unique encoded image in accordance with an embodiment of the invention.

FIG. 8 is an illustration of a server system sending takedown request to service provider A . . . Z in accordance with an embodiment of the invention.

FIG. 9A is an illustration of an image without a digital identifier in accordance with an embodiment of the invention.

FIG. 9B is an illustration of an image with a digital identifier in accordance with an embodiment of the invention.

FIG. 10 is a block diagram of a computer system which may implement, at least in part, a sending device, server system, and/or a service provider in accordance with an embodiment of the invention.

FIG. 11 is a schematic of a system for encoding digital images, the system comprising a sender device, a server system, and an encoding module within the sender device in accordance with an embodiment of the invention.

FIG. 12 is an illustration of a system for encoding digital images, the system comprising a sender device, a server system, and an encoding module external to the sender device in accordance with an embodiment of the invention.

FIG. 13 is an illustration of a system for decoding digital images, the system comprising a requester device, a server system, and a decoding module within the requester device in accordance with an embodiment of the invention.

FIG. 14 is an illustration of a system for decoding digital images, the system comprising a requester device, a server system, and a decoding module external to the requester device in accordance with an embodiment of the invention.

FIG. 15 is a flowchart of a method for blocking an unauthorized share of an image between users directly at the device requesting the share in accordance with an embodiment of the invention.

FIG. 16 is a flowchart of a method for monitoring and then allowing a share of an image between users in accordance with an embodiment of the invention.

FIG. 17 is a flowchart of a method for blocking an unauthorized share of an image between users at a service provider in accordance with an embodiment of the invention.

### DETAILED DESCRIPTION OF THE INVENTION

Approaches for managing one or more shares of an image are presented herein. In the following description, for the purposes of explanation, numerous specific details are set forth to provide a thorough understanding of the embodiments of the invention described herein. It will be apparent, however, that the embodiments of the invention described herein may be practiced without these specific details. In other instances, well-known structures and devices are shown in block diagram form or discussed at a high level to avoid unnecessarily obscuring teachings of embodiments of the invention.

### Functional Overview

An object of an embodiment of the invention is achieved by a system for providing auxiliary information linked to an image encoded with one or more digital identifiers. The system of an embodiment comprises at least one sender device that each comprise a communication module and an encoding module adapted to encode an image with one or more digital identifiers and to create one or more digital identifier keys. In an embodiment, a sender device is configured to perform the following steps when uploading an image to a recipient: (a) encoding the image with one or more digital identifiers, thereby creating an encoded image, (b) creating one or more digital identifier keys of said encoded image as a function of the one or more digital identifiers, (c) creating auxiliary information, the auxiliary information including at least a share statement, (d) linking the auxiliary information to the one or more digital identifier keys, (e) sending the one or more digital identifier keys and auxiliary information to a server system, and (f) uploading the encoded image to the recipient.

The system of an embodiment also comprises a server system that comprises a registry comprising a plurality of digital identifier keys linked to auxiliary information. The server system of an embodiment is configured to perform the following steps when receiving a request image from a requester: (a) searching the request image for encoded digital identifiers as a function of the plurality of digital identifier keys, and (b) sending at least the share statement linked to the digital identifier key to the requester.

The system of an embodiment comprises at least one sender device and the server system, where information related to the image is stored. Thereby, the server system becomes a centralized server enabling at least in principle any requester to receive auxiliary information linked to the image via the digital identifier. The requester may not receive all auxiliary information; however, the requester will at least receive the share statement.

The share statement may be chosen from the non-exhaustive list comprising: (a) all sharing allowed, (b) all sharing allowed-image may not be used for profile picture, (c) all sharing allowed-image may only be used for profile picture for the following accounts and handles (followed by a list of accounts and handles), (d) all sharing allowed at a specific service provider, otherwise no sharing allowed, (e) no sharing allowed, and (f) image is confidential-no sharing allowed. The non-exhaustive list of share statement enables the users or owners of the at least one sender device to give global instructions to service provides as each service provider can be the requester requesting an auxiliary information of an image.

As an example, the share statement “all sharing allowed-image may not be used for profile picture” will reduce the risk of creating fake profiles aiming to abuse the good will of an influencer, where the fake profile poses as the influencer.

The sender device may be a smart device, a smart phone, a tablet, a laptop, or a computer device. The sender device comprises the communication module for communicating with the server system and the recipient.

The communication module may be configured to communicate via Bluetooth and/or Wi-Fi, and/or using band cellular network technology such as 4G or 5G, and/or via a wired connection such as an ethernet cable.

The sender device comprises the encoding module, which may be adapted to encode an image with one or more digital identifiers and to create one or more digital identifier keys. Thus, the encoding module of an embodiment may perform the steps of (a) encoding the image with one or more digital identifiers, and (b) creating one or more digital identifier keys of said encoded image as a function of the one or more digital identifiers. The two steps described above may be, but need not be, performed simultaneously by the encoding module. The encoding module may be a processor and/or a GPU or a dedicated unit designed to encode images with one or more digital identifiers.

In the present application, the term image in singular must be interpreted as single image i.e. a photo and as a series of images i.e. a video or a gif.

The digital identifier will be discussed later in greater detail. However, the digital identifier may be metadata and/or a digital watermark encoded into the image. The digital watermark is essentially a pattern, which the digital identifier key will enable a computer such as the server system to recognize faster and more energy efficient compared to not having digital identifier key.

Furthermore, the step of searching for a digital identifier such as a watermark in an image using digital identifier key is computational more energy efficient than comparing whether two images are identical since a 4K image contain 3840×2160 pixels, while the digital identifier is contained in a subset of the image which can be recognized with less computation time since less data is used for the evaluation. This enables the server system to efficiently search the request image for encoded digital identifiers as a function of the plurality of the identifier keys.

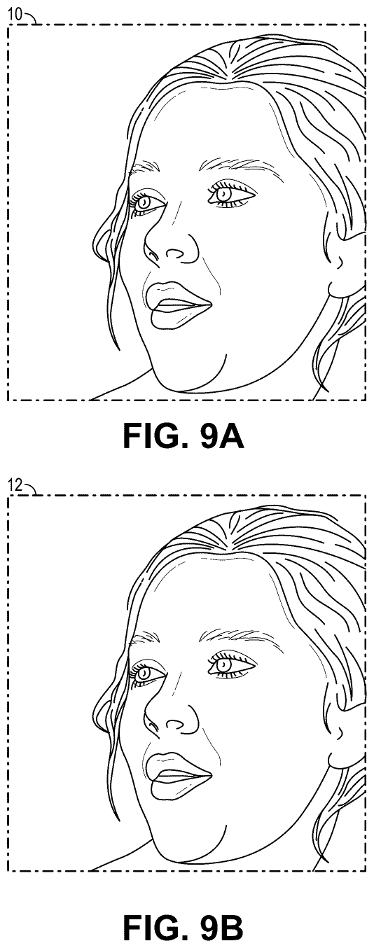

Furthermore, the digital identifier such as a digital watermark will also enable identification of a cropped image, where most of the image has been removed. As an example, the image shown in FIG. 9B could be changed by removing or replacing the background or part of the face, which will make it more difficult to perform a compare with FIG. 9A. However, the digital fingerprint will still be part of one or more subsets of the image, which the server system with the corresponding digital key will be able to recognize. Thus, the server system would be able to provide at least the share statement even if the image has been modified.

The requester sending the request image to the server system could in theory be any natural person or any legal person. However, in practice there may be non-technical reasons for not enabling any natural person or any legal person to request a share statement; the non-technical reason may be the General Data Protection Regulation (GDPR) rules in the European Union (EU) or other national laws or other federal laws.

The step of sending at least the share statement linked to the requester digital identifier key to the requester may include other parts of the auxiliary information depending on the level of security set by the original sender and/or who the requester is.

In an aspect, the auxiliary information includes at least one or more of the following: (a) recipient ID, (b) contact details of the recipient, (c) sender ID, (d) contact details of the sender, and (e) user names or handles to one or more social medias linked to the sender device. The sender ID and the contact details of sender refer to the owner or the user of the sender device. The owner or the user of the sender device may be a natural person or legal person. Likewise, the recipient ID and the contact details of the recipient refer to the natural person or legal person being the recipient. The list of the auxiliary information is not an exhaustive list of all possible auxiliary information. The list represents auxiliary information, which can be used by the server system to notify the owner or user of the sender device that the image has been identified based on an image received by a requester. In the case, where the requester is a service provider, then this information may be sent to the owner or the user of the sender device.

In an aspect of the invention, the recipient may be a service provider and the encoded image may be publicly available at the service provider. The service provider may be reddit or an open online forum or Instagram or YouTube any other service provider having publicly available images provided by users. Even though the encoded image was uploaded to the service provider and made publicly available then it may not mean that the owner or user of the sender device is interested in the image being shared on other websites or apps provided by other service providers.

The sharing of the image can be limited by choosing a specific share statement linked to the one or more digital identifiers, informing any service provider not to share the encoded image. Thereby, the owner or user of the sender device will be able to communicate indirectly with any service provider through the registry at the server system.

In an aspect, the system may be configured to link the recipient to a confidential image encoded with one or more digital identifiers, where (a) the step of encoding the image with one or more digital identifiers includes one or more recipient-unique digital identifiers, thereby creating a recipient-unique encoded image, and (b) the step of creating auxiliary information includes recipient ID enabling identification of the recipient.

The image to be sent to the recipient may contain confidential information, such as, but not limited to, an image of a prototype for a new product to be launched or picture of a nude person. In the first case, the sharing of the confidential information may cause lost revenue since it may not be possible to file for a patent or design patent. In the second case, the sharing of the confidential information may cause personal distress for the person in the image. In both cases, it can be very difficult to prove that the recipient has acted in bad faith and/or at least have breached the confidentiality, since the image could be and may have been sent to a series of recipients or the image could have been uploaded by owner or user of the sender device. Thus, the recipient-unique encoded image having digital identifiers unique for the recipient and thus recipient-unique digital identifier keys linked to the auxiliary information includes recipient ID enabling identification of the recipient. Thereby, the system can be used in forensics for proving that the image is the recipient-unique encoded image and thus must have been leaked from the recipient.

Under national law or federal law. the recipient may have to approve the logging of the recipient ID.

In an aspect, the sender device is configured to receive user input about one or more areas of the image, where the step of encoding the image with one or more digital identifiers includes encoding one or more digital identifiers in the areas of the image.

The sender device may be configured to receive user input through a touchscreen such that a user can mark which areas of the image must include at least one digital identifier. This may be relevant in the case of a prototype for a new product or a nude person. In the case of the nude person, the areas of the image may the area of a genitalia or breasts or any other area which is deemed sensitive to the user providing the user input.

In an aspect, the one or more digital identifier keys enable identification of at least one or more of the following: (a) metadata of the image, (b) human-visible watermark encoded in the image, (c) a Discrete Wavelet Transform (DWT) watermark encoded in the image, (d) a Discrete Cosine Transform (DCT) watermark encoded in the image, and (e) a watermark encoded in the image using a ML-model trained for this purpose. The metadata of the image and the human-visible watermark will for a person acting in bad faith be relatively easy to remove; however, DWT watermarks, DCT watermarks and watermarks encoded in the image using an ML-model trained for this purpose are much harder to remove for the average person.

In an aspect, the server system performs an act of changing the auxiliary information linked to one or more digital identifiers as function of a request from an owner of the sender device.

The owner or user of the sender device may, due to the information received by the server system, wish to change the share statement of the encoded image. This may be prompted by a notification from the server system informing that an image has been shared or that the share statement linked to a digital identifier of the encoded image has been requested indicating that unknown third parties are sharing the encoded image.

An object of the invention is achieved by a method for a service provider to act according to an auxiliary information including a share statement linked to an image, where a user has uploaded an image to the service provider; the method comprising the steps of (a) sending the image to a server system comprising a registry with a plurality of one or more digital identifier keys linked to auxiliary information including at least a share statement, (b) searching in the image for one or more encoded digital identifiers as a function of the one or more digital identifier keys; and when identifying a digital identifier sending at least the share statement of the image to the service provider, and (c) acting as a function of the share statement.

A service provider receiving an image from a user can check whether this image has a share statement restriction by sending the image to the server system which may be the search for digital identifiers and when finding the digital identifier provide the at least the share statement of the image to the service provider. Thereby, the service provider will be able to act according to the share statement. This will in effect limit the sharing of the image.

In an aspect, the server system performs as a function of the auxiliary information linked to the digital identifier a step of alerting a sender having encoded the image with digital identifiers.

The sender will be the owner or user of a sender device functioning in the system as described above.

In other embodiments, the server system may search for digital identifiers linked to images having a share statement being confidential or takedown or similar, where the server system sends takedown requests to a service provider or service providers hosting said images.

An object of the invention is achieved by a method for a service provider to act according to a change of auxiliary information including a share statement linked to one or more digital identifiers of an image, where a user has uploaded an image to the service provider, the service provider performs (a) encoding the image with one or more digital identifiers, thereby creating an encoded image, (b) creating one or more digital identifier keys of said encoded image as a function of the one or more digital identifiers, (c) creating auxiliary information, the auxiliary information including at least a share statement, (d) linking the auxiliary information to the one or more digital identifier keys, and (e) sending the one or more digital identifier keys and auxiliary information to a server system. When the service provider receives a request for a change of the share statement linked to the one or more digital identifier keys from the user, the service provider may perform: (a) changing the share statement linked to the one or more digital identifier keys, and (b) acting according to the share statement.

The method described above functions similarly to the previously described system, however, here the service provider ensures that the image is encoded with a digital identifier by performing the necessary steps as described above. The service provider will thereby enable the user to be able to change the share statement at a later time.

An object of the invention is achieved by a system for providing auxiliary information linked to an image encoded with one or more digital identifiers, the system comprising: (a) a server system, (b) at least one sender device comprising a communication module, wherein the encoding module is adapted to encode an image with one or more digital identifiers and to provide a digital identifier key, and wherein the sender device is configured to perform the following steps when capturing an image: (a) encoding the image with one or more digital identifiers, thereby creating an encoded image, (b) creating one or more digital identifier keys of said encoded image as a function of the one or more digital identifiers, (c) creating auxiliary information, the auxiliary information including at least a share statement, (d) linking the auxiliary information to the one or more digital identifier keys, and (e) sending the one or more digital identifier keys and auxiliary information to the server system. The server system performs a step of storing the one or more digital identifier keys and auxiliary information. The system is similar to the system previously described, but in this case an image or images are being encoded without the image ever being shared. However, the server system will still build a registry comprising of digital identifier keys linked to auxiliary information. Thus, in the case that the sender device is hacked, the owner or user of the sender device may still use the digital identifiers to send takedown notices to various service providers.

In some embodiments, the requester device comprises a decoding module. In some alternative embodiments, the decoding module is external to the requester device. The requester device is a device trying to share an image that was previously encoded by the sender device.

The requester device may be the same recipient device to which the sender device uploaded the image whilst encoding it. Alternatively, the requester device may be another device which has received the encoded image (i.e., the image encoded whilst uploading to the recipient).

The decoding module is used to extract the digital identifiers from the encoded image. The decoding module may then send the extracted digital identifiers to the server system, which looks up for the share statement associated with the encoded image. This may be done in order to check that the encoded image would not been shared in breach of the share statement.

In some examples, the decoding module may be part of a service provider or an intermediate party which is in communication with the service provider. In some examples, the decoding module may be part of a content moderation system of the service provider, and extracts digital identifiers, instructing the server system to look up for the share statement as part of their content moderation activities.

An attempt from the requester device to share the request image may comprise the selection, by the user, of a send command. For example, if the service provider comprises a chat, the user may press “send image” on the chat platform, after selecting the request image. Normally, after the user presses the “send image” command, the image is shared on the chat.

According to some embodiments of the invention, pressing the “send image” command would not automatically be followed by the transmission of the image to the one or more other users, but it would instead be followed by the transmission of the encoded image to the decoding module, which can either be directly within the requester device or part of the service provider. The decoding module then extracts the digital identifiers, which are sent to the server system.

Following the receipt of the digital identifiers, the server system of an embodiment searches the one or more digital identifier keys associated with the encoded image as a function of the one or more digital identifiers received from the decoding module. Upon receipt of the share statement, the requester device or the service provider of an embodiment may then analyze the share statement, and proceed to either block the share attempt or authorize it. Advantageously, this provides an automatic image-sharing-monitoring system which can be used to prevent unauthorized image sharing. In this way, image sharing can be monitored automatically with enhanced accuracy and reliability by deciding whether an image should be shared or not based on the share statement which has been previously created whilst the image was encoded.

Advantageously, this can be done via share-specific digital identifiers, which are created every time the sender device uploads (shares) the image to a recipient device. In this way, every share can be tracked through the associated share-specific digital identifiers, auxiliary information and share statements.

Advantageously, this solution can be part of an automatic content moderation system which is configured to moderate content on the service provider, in a way that directly aligns with the share statement. This approach removes the need for manual content moderation, which is costly and often leads to under-moderation or over-moderation that can be poorly reflective of the real wishes of the content creators and authors. When the decoding module is part of the requester device, there is the further advantage that the server(s) of the service provider do not need to check for unauthorized image shares. This can offload the service provider servers of a significant share of activities.

According to other examples, a requester device may share the request image with one or more receiving users, before the decoding module can extract and send the digital identifiers to the server system. In other words, the check on the share occurs after the share has happened. In these cases, the service provider may be configured to intercept the transmission of the request image and verify whether said image share should have been allowed or not. This is done via the receipt at the service provider, from the server system, of the share statement corresponding to the shared image. If the share is found to be in breach of the share statement, the service provider may decide to take any of the following action: take down the shared image, take legal action against the requester device and/or against the one or more receiving users, restrict availability of the shared image, notify the sender device and/or an owner and/or author of the shared image.

### DRAWING REFERENCES

In the figures of the accompanying drawings, like reference numerals refer to similar elements, namely:

| Item | Reference number |
|---|---|
| Image | 10 |
| Encoded image | 12 |
| Recipient-unique encoded image | 14 |
| Owner | 18 |
| User | 20 |
| Recipient | 25 |
| Sender device | 30 |
| Requester device | 39 |
| Encoding module | 32 |
| Communication module | 34 |
| Decoding module | 36 |
| Server system | 40 |
| Registry | 42 |
| Digital identifier | 50 |
| Digital identifier key | 52 |
| Service provider | 60 |
| Auxiliary information | 70 |
| Share statement | 72 |

### Managing Image Shares

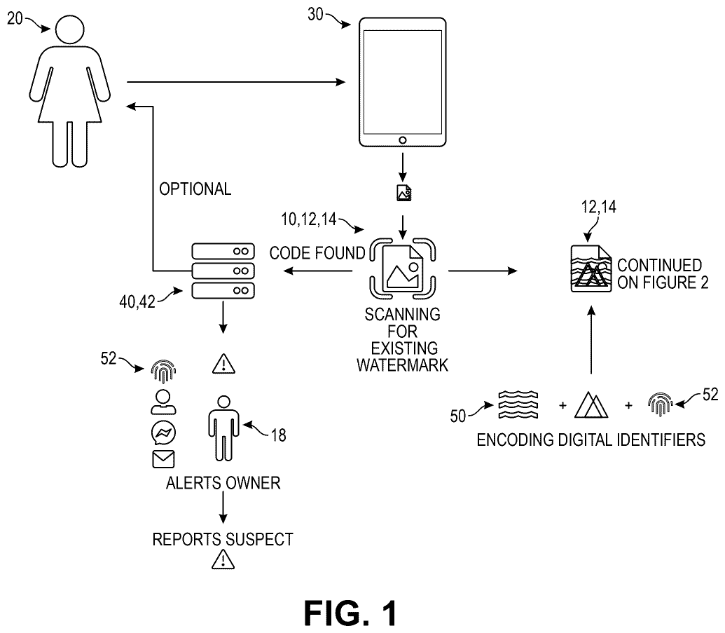

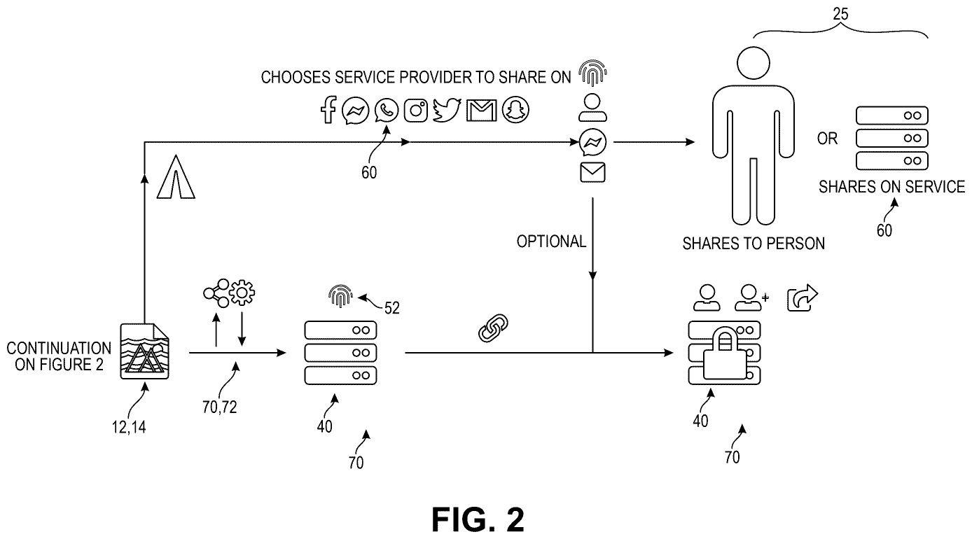

FIGS. 1-2 illustrate a user 20 uploading an image 10, 12, 16 via a sender device 30 to a recipient 25. In this embodiment, the sender device 30 searches or scans for a digital identifier 50 and if a digital identifier 50 is found or at least if the sender device 30 deems there may be a digital identifier 50 encoded in the image 10, then the image 10 being an encoded image 12 or a recipient-unique encoded image 14 is sent to a server system 40. The server system comprises a registry 42 comprising a plurality of digital identifier keys 52 linked to auxiliary information 70. The server system 40 performs a step of searching the encoded image 12, 14 for encoded digital identifiers 50 as a function of the plurality of digital identifier keys 52.

If a digital identifier 50 is found based on a digital identifier key 52 is found, then the auxiliary information 70 linked to said digital identifier key 52 may enable the server system 40 to send a warning to an owner 18 of the encoded image 12, 14. The owner 18 may if the image is a recipient-unique encoded image 14 take legal actions against the recipient 25 who received the recipient-unique encoded image 14.

If the image 10 contains no digital identifiers 50, then the sender device 30 performs a step of encoding the image 10 with one or more digital identifiers 50 and/or one or more recipient-unique digital identifiers 50, thereby creating an encoded image 12 or a recipient-unique encoded image 14, and the sender device 30 performs a step of creating one or more digital identifier keys 52 of said encoded image 12 or recipient-unique encoded image 14 as a function of the one or more digital identifiers 50.

As shown in FIG. 2, the sender device further performs a step of creating auxiliary information 70 including at least a share statement 72. The auxiliary information 70 may at least in part be based on user input. The one or more digital identifier keys and the auxiliary information 70 are sent to and stored on the server system 40. The server system 40 comprises an at least partly public registry 42 of the server system containing digital identifier keys linked to the share statements 72 such that a requester may be informed whether an image may be shared or not.

In an embodiment, server system 40 may comprise a secured registry (indicated by the lock) containing auxiliary information 70 enabling the owner of the encoded image 12 to be contacted or may contain information enabling identification of the recipient 25.

The encoded image 12, 14 may afterwards be uploaded to the recipient 25, this may be through varies service providers 60. The shown service providers 60 are Facebook, Messenger, WhatsApp, Instagram, Twitter, Gmail, and Snapchat. The list of service providers 60 is non-exhaustive.

The recipient 25 may be a natural person or a legal person such as a service provider 60, where the encoded image is made publicly available through the service providers 60.

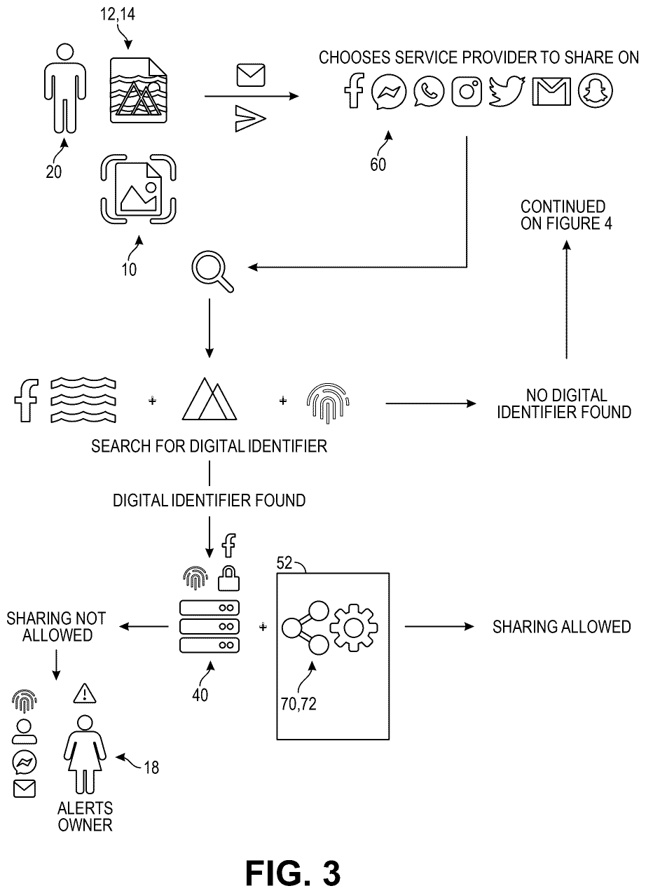

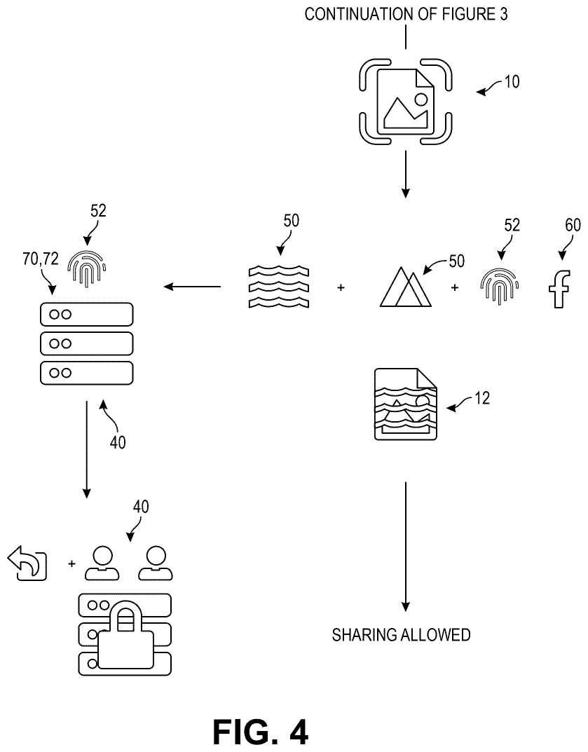

FIGS. 3-4 illustrate a user 20 uploading an image 10 to a service provider 60. The shown service providers 60 are Facebook, Messenger, WhatsApp, Instagram, Twitter, Gmail, and Snapchat. The list of service providers 60 is non-exhaustive.

The service provider 60 may not know whether the image 10 contain digital identifiers or whether the user 20 is sharing a confidential image being an encoded image 12 or a recipient-unique encoded image 14.

Using an embodiment, service provider 60 may search for a digital identifier or request the server system 40 to search for a digital identifier as a function of the stored digital identifier keys 52.

If a digital identifier is found based on a digital identifier key, then the share statement is checked and the encode image 12, 14 may be shared if the share statement 72 allows sharing or the encoded image 12, 14 may not be shared if the share statement 72 does not allow sharing. Depending on the other parts of the auxiliary information 70 linked to the digital identifier key 52, then the owner 18 of the encoded image 12, 14 may be warned.

As shown in the embodiment of FIG. 4, when no digital identifier found, then the service provider 60 may perform a step of encoding the image 10 with one or more digital identifiers 50, thereby creating an encoded image 12, and the service provider 60 may perform a step of creating one or more digital identifier keys 52 of said encoded image 12 as a function of the one or more digital identifiers 50.

The service provider 60 may then performs a step of creating auxiliary information 70 including at least a share statement 72. The one or more digital identifier keys and the auxiliary information 70 are sent to and stored on the server system 40. The server system 40 comprises an at least partly public registry 42 of the server system containing digital identifier keys linked to the share statements 72 such that a requester may be informed whether the image 12 may be shared or not. The service provider 60 may then share the encoded image 12.

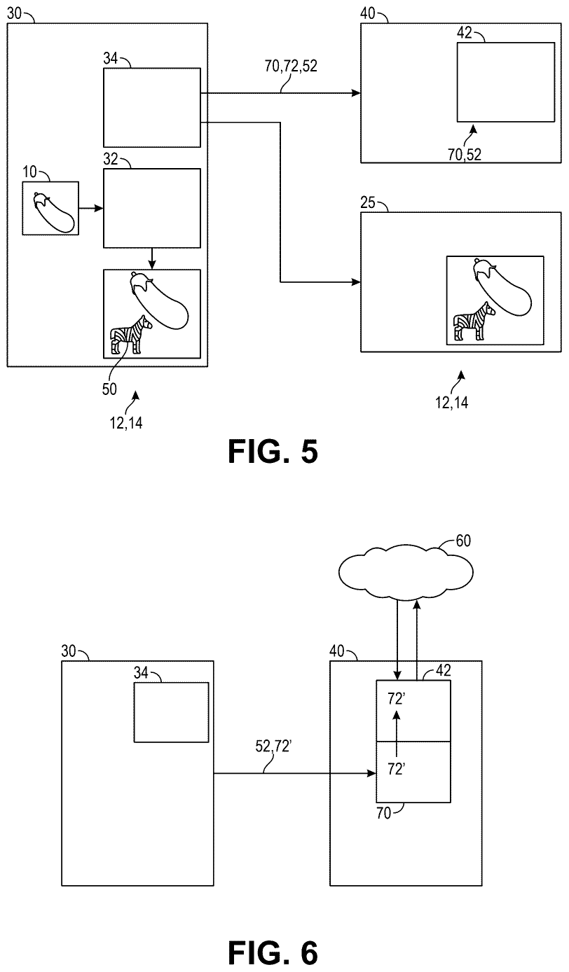

FIG. 5 is an illustration of a system according to an embodiment of the invention. Note that while recipient 25 is shown in FIG. 5, recipient 25 is not part of the system. The system of FIG. 5 comprises at least one sender device 30 and a server system 40. Sender device 30 comprises a communication module 34 for communicating with recipient 25 and server system 40.

The sender device 30 also comprises an encoding module 32 adapted to encode an image 10 with one or more digital identifiers 50 and to provide a digital identifier key 52 (not shown). The image 10 is in this case of an eggplant. In the present example the encoded image 12 contains a digital identifier 50 in the form of a zebra watermark; the digital identifier 50 will typically be designed to invisible for the human eye.

In an embodiment, sender device 30 is configured to perform the following steps when capturing an image 10 or when sending an image 10 or when prompted by a user input: (a) a step of encoding the image 10 with one or more digital identifiers 50, thereby creating an encoded image 12, (b) a step of creating one or more digital identifier keys 52 of said encoded image 12 as a function of the one or more digital identifiers 50, (c) a step of creating auxiliary information 70, the auxiliary information including at least a share statement 72, (d) a step of linking the auxiliary information 70 to the one or more digital identifier keys 52, and (e) a step of sending the one or more digital identifier keys 52 and auxiliary information 70 to the server system 40.

The server system 40 comprising a registry 42 containing a plurality of digital identifier keys 52 linked to auxiliary information 70. The purpose of the digital identifier keys 52 is to enable faster recognition of digital identifiers 50 in an image 50, while at the same time link the digital identifiers 50 of an image 10 with auxiliary information 70 including at least a share statement 72.

FIG. 6 is an illustration of a service provider 60 requesting a share statement 72 and a sender device 30 requesting a change in the share statement 72 to 72′ in accordance with an embodiment. The server system 40 comprising a registry 42 containing a plurality of digital identifier keys 52 (not shown) linked to auxiliary information 70. The server system 40 of an embodiment is configured to perform the following steps, when receiving a request image from a requester, which in this embodiment is the service provider 60: (a) a step of searching the requested image 10 for encoded digital identifiers 50 as a function of the plurality of digital identifier keys 52, and (b) a step of sending at least the share statement 72 linked to the digital identifier key 52 to the requester being service provider 60. The sender device 30 requests that the share statement linked to digital identifier key 52 is changed to share statement 72′, which may be “sharing not allowed” or “sharing allowed.” The system server 40 will thereafter provide the share statement 72′ for the digital identifier key 52.

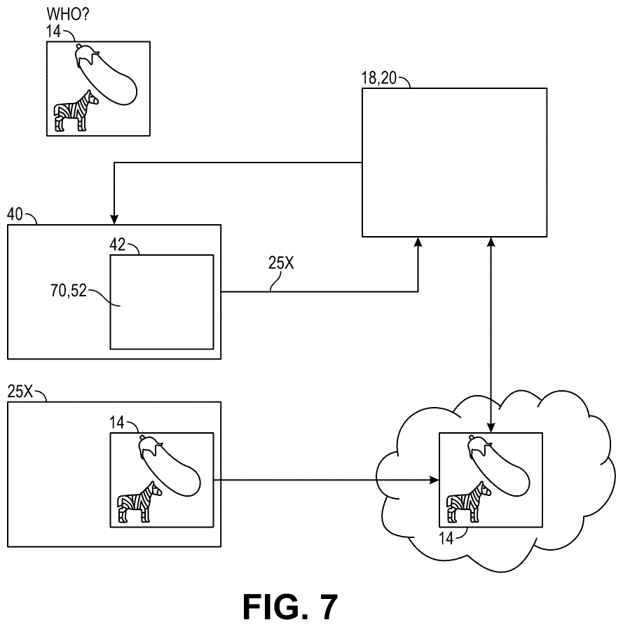

FIG. 7 is an illustration of an owner 18 or user 20 requesting information of the recipient 25, who has leaked a recipient-unique encoded image 14, in accordance with an embodiment of the invention. In the example shown in FIG. 7, recipient 25X has leaked the recipient-unique encoded image 14 to the internet represented by the cloud. The owner 18 or user 20 has found the image 14 and request the system server 40 for the recipient 25 of the recipient-unique encoded image 14, which the system server 40 is able to provide as the recipient 25X. The owner 18 or user 20 may then instigate legal proceedings against the recipient 25X.

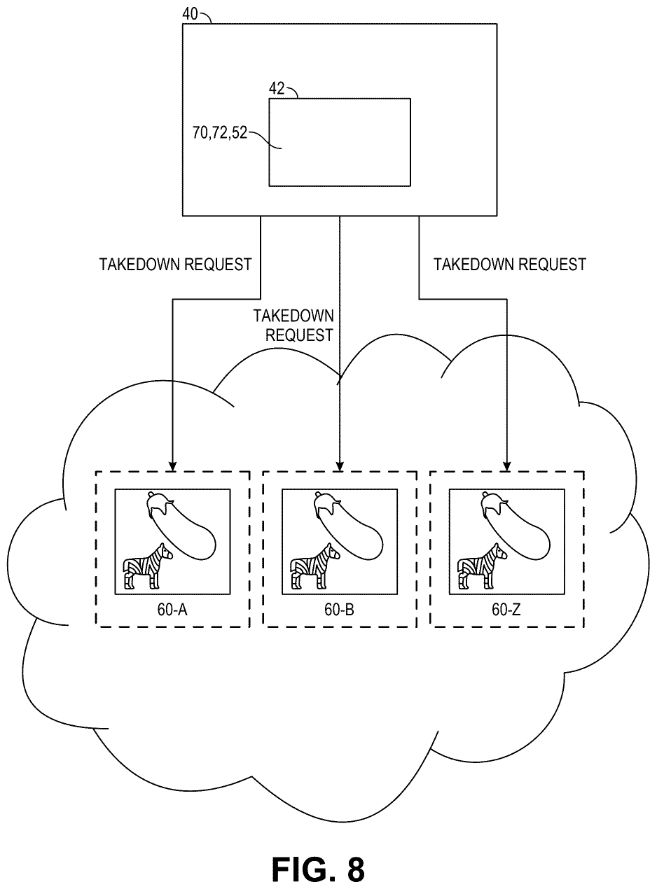

FIG. 8 illustrates a server system 40 sending a takedown request to service provider 60A, . . . , service provider 60Z in accordance with an embodiment of the invention. The server system 40 crawls the service providers 60A-60Z in search of digital identifiers 50 linked to a digital identifier key 52.

FIG. 9A is an illustration of an image 10 without a digital identifier in accordance with an embodiment of the invention. FIG. 9B is an illustration of an image 12 with a digital identifier in accordance with an embodiment of the invention. Image 12 depicted in FIG. 9B possesses a 128-bit digital identifier.

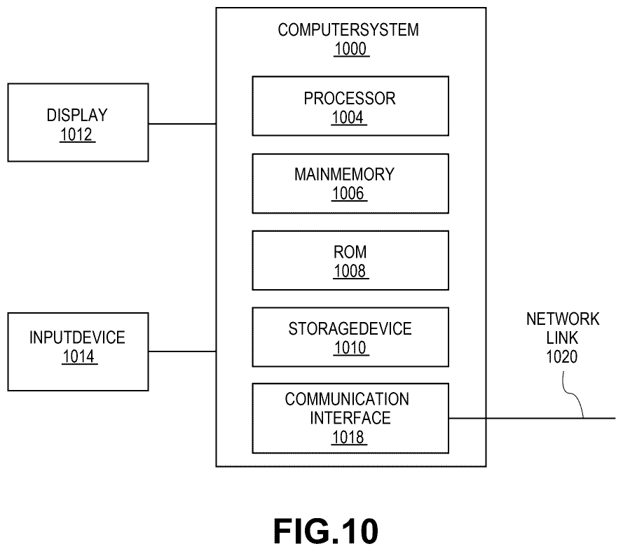

FIG. 10 is a block diagram of a computer system which may implement, at least in part, a sending device, server system, and/or a service provider in accordance with an embodiment of the invention. In an embodiment, computer system 1000 includes processor 1004, main memory 1006, ROM 1008, storage device 1010, and communication interface 1018. Computer system 1000 includes at least one processor 1004 for processing information. Computer system 1000 also includes a main memory 1006, such as a random-access memory (RAM) or other dynamic storage device, for storing information and instructions to be executed by processor 1004. Main memory 1006 also may be used for storing temporary variables or other intermediate information during execution of instructions to be executed by processor 1004. Computer system 1000 further includes a read only memory (ROM) 1008 or other static storage device for storing static information and instructions for processor 1004. A storage device 1010, such as a magnetic disk or optical disk, is provided for storing information and instructions.

Embodiments of the invention are related to the use of computer system 1000 for implementing the techniques described herein. According to one embodiment of the invention, those techniques are performed by computer system 1000 in response to processor 1004 executing one or more sequences of one or more instructions contained in main memory 1006. Such instructions may be read into main memory 1006 from another machine-readable medium, such as storage device 1010. Execution of the sequences of instructions contained in main memory 1006 causes processor 1004 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

Processor 1004 may include one or more processing units (e.g., in a multi-core configuration) for executing instructions. The instructions may be executed within a variety of different operating systems on the computer system 1000, such as UNIX, LINUX, Microsoft Windows®, and the like. More specifically, the instructions may cause various data manipulations on data stored in memory 1006 (e.g., create, read, update, and delete procedures). It should also be appreciated that upon initiation of a computer-implemented method, various instructions may be executed during initialization. Some operations may be required in order to perform one or more methods described herein, while other operations may be more general and/or specific to a particular programming language (e.g., C, C#, C++, Java, or other suitable programming languages, etc.).

The term “non-transitory computer-readable storage medium” as used herein refers to any tangible medium that participates in storing instructions which may be provided to processor 1004 for execution. Non-limiting, illustrative examples of non-transitory machine-readable media include, for example, a solid-state device, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of non-transitory computer-readable media may be involved in carrying one or more sequences of one or more instructions to processor 1004 for execution. For example, the instructions may initially be carried on a magnetic disk of a remote computer. The remote computer can load the instructions into its dynamic memory and send the instructions over a network link 1020 to computer system 1000.

Processor 1004 is operatively coupled to a communication interface 1018, such that the computer system 1000 is capable of communicating with a remote device or server, such as a server system. Communication interface 1018 provides a two-way data communication coupling to a network link 1020 that is connected to a local network. For example, communication interface 1018 may be an integrated services digital network (ISDN) card or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through a local network to a host computer or to data equipment operated by an Internet Service Provider (ISP).

Computer system 1000 can send messages and receive data, including program code, through the network(s), network link 1020 and communication interface 1018. For example, a server might transmit a requested code for an application program through the Internet, a local ISP, a local network, subsequently to communication interface 1018. The received code may be executed by processor 1004 as it is received, and/or stored in storage device 1010, or other non-volatile storage for later execution.

Processor 1004 may also be operatively coupled to a storage device 1010 such as storage medium via a storage interface. The storage device 1010 is any computer-operated hardware suitable for storing and/or retrieving data. In some cases, e.g. a remotely located storage medium, communication interface 1018 may perform the function of storage interface 1010 such that these two entities are combined.

The storage device 1010 can be integrated in computer system 1000 (such as shown in FIG. 10), or it can be external to computer system 1000 and located remotely. For example, computer system 1000 may include one or more hard disk drives as a storage device. Alternatively, where the storage device 1010 is external to computer system 1000, it can comprise multiple storage units such as hard disks or solid-state disks in a redundant array of inexpensive disks (RAID) configuration. The storage device may include a storage area network (SAN) and/or a network attached storage (NAS) system.

Processor 1004 may be operatively coupled to the storage device 1010 via a storage interface (not illustrated). Storage interface is any component capable of providing processor 1004 with access to the storage device 1010. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1004 with access to the storage device.

The memory may include a read-only memory 1008 (ROM) in communication with the main memory 1010. The memory may include, in alternative to the ROM or in combination with it, random-access memory (RAM) such as dynamic RAM (DRAM) or static RAM (SRAM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

The computer system 1000 may be in communication with a display 1012. For example, if the sender is a mobile phone, the display 1012 may be a touch screen or other type of screen of the mobile phone. The computer system 1000 may be connected to a network via network link 1020. For example, if the sender device is a mobile phone, its computer system may be connected to the internet via Wi-Fi, 4G or 5G connection.

The computer system 1000 may be connected to an input device 1014. For example, the input device 1014 may be a mobile phone, a computer or the like. The input device 1014 may be used to transmit images and/or communication messages to the computer system 1000.

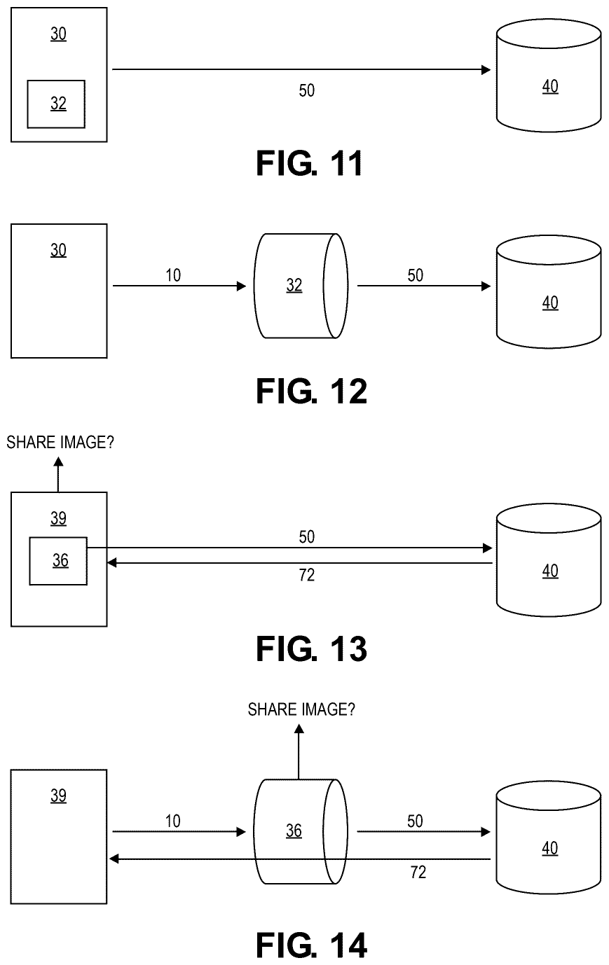

FIG. 11 depicts a system for encoding digital images. The system shown in FIG. 11 comprises a sender device 30, an encoding module 32, and a server system 40. In the example of FIG. 11, encoding module 32 is part of the sender device 30. Therefore, the image 10 is encoded with the one or more digital identifiers 50 within the sender device 30. After sender device 30 encodes the image 10, sender device 30 transmits the one or more digital identifiers 50 to the server system 40.

FIG. 12 depicts an alternate to the embodiment shown in FIG. 11, as FIG. 12 depicts an encoding module external to sender device 32. For example, the encoding module may be a separate server under the control of service provider 60. In this example, sender device 30 transmits the image 10 to be encoded to the encoding module 32, which then encodes it with the one or more digital identifiers 32. The one or more digital identifiers 50 are then sent from the encoding module 32 to the server system 40.

Choosing to incorporate the encoding module in the sender device 30 or in an external server depends on the needs of the specific system. An advantage of incorporating the encoding module within the sender device 30 is that this approach offloads an external service provider, such as a social media platform, of encoding the images. On the other hand, a service provider may prefer to hold all the encoding processes for images shared on the service provider centrally, on their own server. This system can be adapted to both circumstances.

FIG. 13 depicts a system comprising a requester device 39, a decoding module 36, and a server system 40. Requester device 39 is a device which may be used to share or to attempt to share an image. This image may be the image 10 which was encoded and uploaded to a recipient (which may be the requester device itself) by sender device 30. In this example, decoding module 36 is part of the requester device 39 and is used to verify with the server system whether an encoded image can be shared or not.

In an embodiment, the verification process may occur through the following steps. The decoding module decodes the encoded image and extracts the one or more digital identifiers 50. The one or more digital identifiers 50 are then transmitted from the sender device 36 to the server system 40 by the requester device. The server system 40 comprises the registry with a plurality of digital identifier keys linked to corresponding auxiliary information. The server system 40 therefore performs a search of this registry. More specifically, the server system 40 searches the registry for the one or more image-share-specific digital identifier keys associated with the encoded image 10 as a function of the one or more digital identifiers 50 received from the requester device 39. If the one or more digital identifiers 50 are found, the server system 40 will be able to retrieve the auxiliary information linked to the corresponding one or more digital identifier keys. Then, the share statement 72 included in the auxiliary information is extracted. Finally, the server system 40 sends the share statement or a message indicative of a content of the share statement to the requester device 39. For example, if the share statement forbids any share of the encoded image 10, the message 72 may be “do not share the image”.

Advantageously, this system allows a service provider such as a message platform or social media platform to offload the decoding and encoding processes to the requester device itself, which may be a device of a user of the service provider.

FIG. 14 depicts a system of an embodiment similar to the one shown by FIG. 13, with the difference that the decoding module 36 is separate from the requester device 39. In the embodiment of FIG. 14, the decoding module 36 runs on a separate server. The encoded image 10 is sent from the requester device 39 to the decoding module 36, and the decoding module 36 extracts the one or more digital identifiers 50 which are then transmitted to the server system 40, which extracts the share statement 72 and either sends, to the requester system 39, the share statement 72 or a message 72 indicative of a content of the share statement.

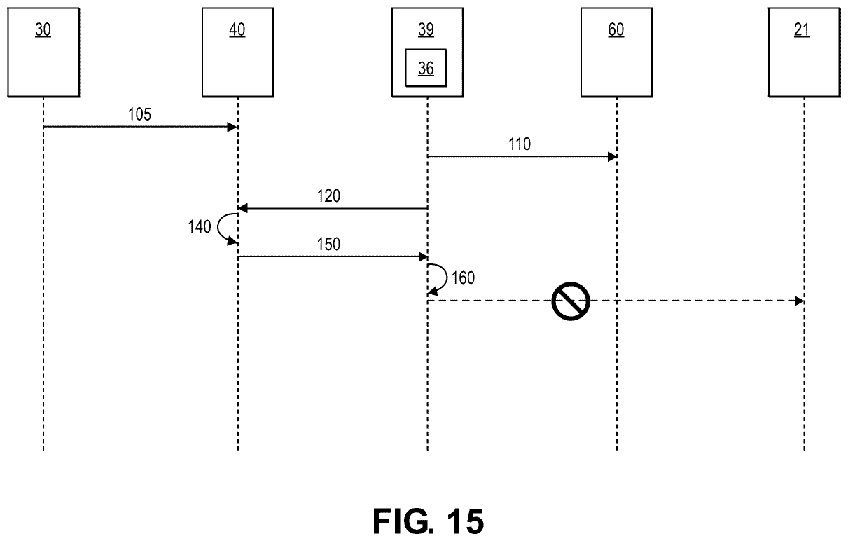

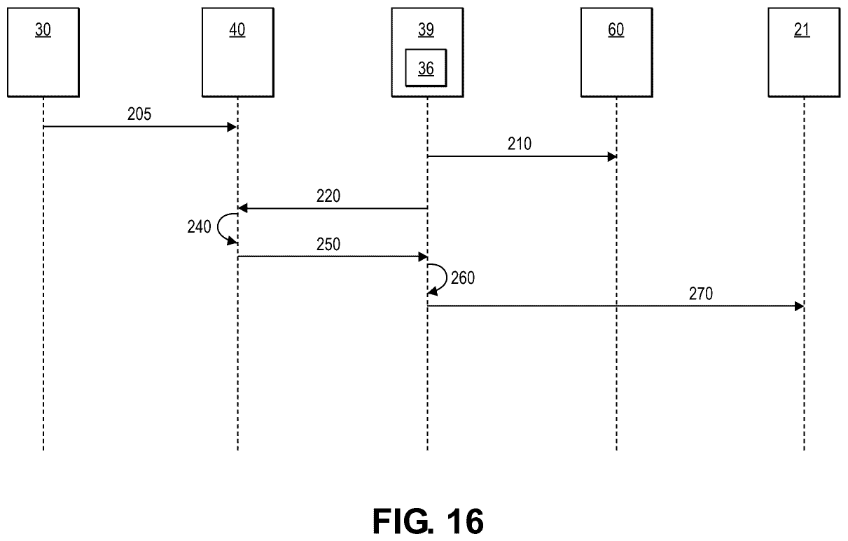

With reference to FIGS. 15 and 16, there are provided two embodiments of the invention, where a requester device 39 uses the server system 40 to check whether they can share with a receiving user 21, via service provider 60, an image 10 that was previously encoded by a sender device 30 (see step 105).

Requester device 39 and receiving user 21 may be members or users of service provider 60. For example, service provider 60 may be a social media service provider or an instant messaging service provider. Users of the service provider may share content through personal accounts to one another. In some examples, receiving user 21 is a plurality of users. In some examples, an image can be shared or attempted to be shared via a group chat or a blog. In these cases, one or more receiving users will share the image with the transmitting user through the group chat, blog or the like.

At step 110, requester device 39 attempts to share an image with receiving user 21 on service provider 60. This attempt may occur through the transmission of a share command or share request message to service provider 60, in order to command or request the transmission of the request image to receiving user 21. The command/request can be a simple prompt to, for example, send the image on a chat of the service provider. For instance, user 21 may request the transmission of the request image in a chat with user 21 by pressing a “send” button in the chat.

Before the image is sent to user 21, the decoding module 36 of the requester device 39 extracts the one or more digital identifiers 50 used to encode the image when this was uploaded to the recipient (which may be requester device 39 or another device). At step 120, the requester device 39 transmits the one or more digital identifiers 50 to the server system 40 for looking up the share statement.

Following the received one or more digital identifiers 50 from the requester device 39, the server system 40 performs a search 140 of the registry for the one or more digital identifier keys associated with the encoded image 10 as a function of the one or more digital identifiers 50 received from the requester device 39.

When the auxiliary information is found in the registry, the share statement 72 is retrieved from the auxiliary information.

The share statement (or a message indicative of a content of the share statement) is therefore sent 150 from the server system 40 to the requester device 39 so that the requester device 39 can analyze it and determine 160, based on the share statement, whether the image can be sent or not to receiving user 21 through service provider 60.

In the embodiment shown in FIG. 15, the check 160 performed at the service provider 60 reveals that, according to the share statement, the request image must not be sent to user 21. For example, this could be because the share statement indicates “no sharing allowed”, or “image is confidential-no sharing allowed.” The sharing will then be blocked by the receiver device 39, or by the service provider 60.

FIG. 16 depicts a similar approach to the one illustrated by FIG. 15, e.g., steps 205 and 210 to 260 are the same as, respectively, steps 105 and 110 to 160. However, in the example of FIG. 16, the share statement check 260 reveals that the request image can be sent from the requester device 39 to the receiving user 21. This can be, for example, because the share statement allows “all sharing”, or may allow all sharing on that specific service provider. Consequently, the image is sent to the receiving user 21 at step 270. The share statement can be transmitted to the requester device 39 from the server system 40, in order to be used for automatic content moderation on social media and messaging platforms.

Advantageously, in these examples of FIGS. 15-16, the check occurs immediately after the requester device 39 attempts to share the encoded image, and before the image can actually be shared. The check has to be completed and the service provider must ensure that the share attempt is compliant with the share statement of the image before the image can be actually shared to user 21. This means that the risk of leaking an image that is not authorized is significantly minimized compared to prior art arrangements.

In some embodiments, the service provider may notify the user of the sender device 30, after the attempted share from the requester device 39.

In some embodiments, decoding module 36 is not in the requester device 39 but is instead part of the service provider, or a third party/intermediate party that mediates communication between the service provider 60 and the server system 40. Such a third party/intermediate party may be part of a content moderation system that is used to moderate content shared on the service provider 60.

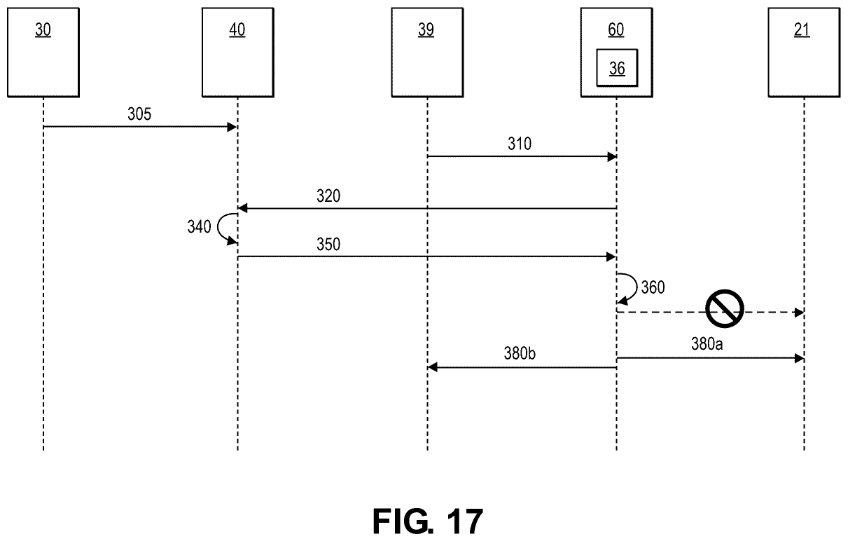

In the embodiment of FIG. 17, a system like the one of FIG. 12 is used to block an unauthorized share of an image, which was previously uploaded to a recipient by sender device 30 and encoded through digital identifiers 50. Step 305 is the step when the auxiliary information is sent to the server system 40 for storage.

At some point after step 305, requester device 39 attempts to share the image with user 21, through service provider 60. This is similar to steps 110-210 of FIGS. 15-16, but with the difference that the decoding module 36 is part of the server provider 60. So, at step 310, the requester device sends the encoded image to the service provider 60, and the decoding module 36 extracts the digital identifiers used to encode the image. The digital identifiers are then sent from service provider 60 to the server system 40, to look up for the auxiliary information and the share statement. Once the share statement is extracted, this, or a message based on a content of the share statement, is transmitted from the server system 40 to the service provider 60. In this example, the share statement forbids shares of the image, so the service provider 60 blocks the share attempt with user 21. In this example, both the requester user 39 and the user 21 are then notified 380 that they attempted to share an image in breach of the share statement. Furthermore, legal action may then be taken against the requester user 39 and/or against the receiving users 21.

In some examples, the service provider 60 checks the share statement after the image has been sent. In these examples, the server system 40 may be notified of the unauthorized share of the image and take action to take down the image from the platform. In some examples, the service provider 60 notifies the sender device 30 of the unauthorized share of the image. In some examples, the service provider 60 notifies the sender device 30 of the unauthorized share of the image through the server system 40.

In the foregoing specification, embodiments of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

1. A system for managing one or more shares of an image, the system comprising:
at least one sender device;
an encoding module; and
a server system,
wherein the at least one sender device is configured to perform the following:
acquire or retrieve the image, and
wherein during a process of uploading the image from the at least one sender device to a recipient device, the encoding module is configured to perform the following steps per-image-share:
(a) encode the image with one or more image-share-specific digital identifiers, thereby creating an image-share-specific encoded image for the specific share,
(b) create one or more image-share-specific digital identifier keys of said image-share-specific encoded image as a function of the one or more image-share-specific digital identifiers,
(c) create image-share-specific auxiliary information, the image-share-specific auxiliary information including at least a share statement for the specific share of the image,
(d) link the image-share-specific auxiliary information to the one or more image-share-specific digital identifier keys,
(e) send the one or more image-share-specific digital identifier keys and image-share-specific auxiliary information to the server system, and
(f) send the image-share-specific encoded image to the recipient device for the specific share of the image; and
wherein the server system comprises a registry, wherein said registry comprises a plurality of digital identifier keys linked to corresponding auxiliary information, wherein the server system performs the following when receiving, from a requester device, the one or more image-share-specific digital identifiers associated with the image-share-specific encoded image:
(1) search the registry for the one or more image-share-specific digital identifier keys associated with the image-share-specific encoded image as a function of the one or more image-share-specific digital identifiers received from the requester device, and
(2) send to the requester device at least one of the share statement linked to the one or more image-share-specific digital identifier keys and a message indicative of a content of the share statement.

2. The system of claim 1, wherein the encoding module is part of the at least one sender device.

3. The system of claim 1, further comprising the requester device and a decoding module.

4. The system of claim 3, wherein the decoding module is configured to perform the following steps, before the server system receives the one or more image-share-specific digital identifiers from the requester device:
receive from the requester device the image-share specific encoded image, extract from the image-share specific encoded image the one or more image-share-specific digital identifiers previously used to encode the image, and
transmit the extracted one or more image-share-specific digital identifiers to the server system.

5. The system of claim 4, wherein the decoding module is part of the requester device.

6. The system of claim 1, wherein the server system receives the one or more image-share-specific digital identifiers associated with the image-share-specific encoded image from the requester device in response to the requester device attempting to share the encoded image with one or more receiving users.

7. The system of claim 6, wherein the one or more receiving users are members of a group chat, and wherein the requester device attempts to share the request image on the group chat.

8. The system of claim 1, wherein, after the server system (2) sends to the requester device at least one of the share statement linked to the one or more image-share-specific digital identifier keys and a message indicative of a content of the share statement, the requester device determines, based on the share statement or the content of the share statement, whether sharing of the encoded image should be permitted or not, and if it is determined that the sharing of the image should not be permitted, the requester device is prevented from sharing the encoded image.

9. The system of claim 1, wherein the server system receives the one or more image-share-specific digital identifiers from the requester device in response to and after the requester device has shared the image-share-specific encoded image with one or more receiving users.

10. The system of claim 9, wherein, after the server system (b) sends at least the share statement to the requester, the requester determines, based on the share statement, whether one or more of the following actions should be taken: request the service provider to take down the image-share-specific encoded image, take legal action against a user of the requester device and/or against the one or more receiving users, restrict availability of the image-share-specific encoded image, notify the at least one sender device and/or an owner and/or author of the image-share-specific encoded image.

11. The system of claim 1, wherein, if the image is shared two or more times, each shared image contains image-share-specific digital identifiers different from the other image-share-specific digital identifiers corresponding to the other shared images.

12. The system of claim 1, wherein the image-share-specific auxiliary information further includes one or more of the following: (a) a recipient identifier (ID) identifying the recipient for a particular image share, (b) contact details of the recipient, (c) a sender identifier (ID), (d) contact details of the sender, and (e) user names or handles to one or more social medias linked to the sender device.

13. The system of claim 1, wherein the recipient is a service provider and the image-share-specific encoded image is made publicly available at the service provider.

14. The system of claim 1, wherein the system is configured to link the recipient to a confidential image encoded with one or more image-share-specific digital identifiers, wherein encoding the image with one or more image-share-specific digital identifiers includes encoding the image with one or more recipient-unique digital identifiers, thereby creating a recipient-unique encoded image, and wherein said auxiliary information includes recipient identifier (ID) enabling identification of the recipient.

15. The system of claim 1, wherein the sender device is configured to receive user input about one or more areas of the image, and wherein the step of encoding the image with one or more image-share-specific digital identifiers includes encoding one or more image-share-specific digital identifiers in said one or more areas of the image.

16. The system of claim 1, wherein the one or more image-share-specific digital identifier keys enable identification of at least one or more of: metadata of the image, a human-visible watermark encoded in the image, a Discrete Wavelet Transform (DWT) watermark encoded in the image, a Discrete Cosine Transform (DCT) watermark encoded in the image, and a watermark encoded in the image via Machine Learning (ML)-based techniques.

17. The system of claim 1, wherein the server system performs changing the image-share-specific auxiliary information linked to one or more image-share-specific digital identifiers as a function of a request from an owner of the sender device.

18. A method for processing a share statement linked to an image uploaded to a service provider, comprising:
the service provider sending the image to a decoding module;
the decoding module extracting one or more digital identifiers used to encode the image;
the decoding module sending the one or more digital identifiers to a server system;
the server system having a registry with a plurality of one or more image-share-specific digital identifier keys linked to image-share-specific auxiliary information including at least the share statement for a specific image share;
the server system searching the registry for the one or more digital identifier keys associated with the encoded image as a function of the one or more digital identifiers received from the decoding module; and
the service provider receiving, from the server system, at least one of the share statement linked to the one or more image-share-specific digital identifier keys and a message indicative of a content of the share statement.

19. The method of claim 18, wherein the service provider sends the image to the server system in response to a user sharing or attempting to share the image with one or more receiving users through the service provider or through another platform.

20. The method of claim 19, wherein the service provider determines, based on the share statement or the message indicative of a content of the share statement, whether the user is permitted or not permitted to share the image with the one or more receiving users.

21. The method of claim 19, wherein, if the user has already shared the image, the service provider further determines, based on the share statement, whether one or more of the following actions should be taken: take down the image, take legal action against the user and/or against the one or more receiving users, restrict availability of the image, notify an owner and/or author of the image.

22. The method of claim 18, wherein, if the image is shared two or more times, each shared image contains image-share-specific digital identifiers different from the other image-share-specific digital identifiers corresponding to the other shared images.

23. A method for a service provider to act according to a change of an image-share-specific auxiliary information including a share statement for a specific share of the image with a recipient, the share statement being linked to one or more image-share-specific digital identifiers of the image, where a user has uploaded the image to the service provider, comprising:
encoding the image with one or more image-share-specific digital identifiers, thereby creating an encoded image for the specific share with a recipient;
creating one or more image-share-specific digital identifier keys of said image-share-specific encoded image as a function of the one or more image-share-specific digital identifiers;
creating image-share-specific auxiliary information, the image-share-specific auxiliary information including at least a share statement for the specific share of the image with the recipient;
linking the image-share-specific auxiliary information to the one or more image-share-specific digital identifier keys;
sending the one or more image-share-specific digital identifier keys and the image-share-specific auxiliary information to a server system; and
upon receiving a request for a change of the share statement linked to the one or more digital image-share-specific identifier keys from the user, causing the share statement linked to the one or more image-share-specific digital identifier keys to be changed.

24. The method of claim 23, wherein the request for the change of the share statement is received from a requester in communication with the service provider in response to one or more of: a request from an owner of the image, attempted share of the image on the service provider, a share of the image on the service provider.

25. The method of claim 23, wherein, if the image is shared two or more times, each shared image contains image-share-specific digital identifiers different from the other image-share-specific digital identifiers corresponding to the other shared images.

26. A system for providing auxiliary information linked to an image that, after being captured, is encoded with one or more digital identifiers, comprising:
a server system; and
at least one sender device comprising a communication module and an encoding module adapted to encode an image with one or more digital identifiers and to provide a digital identifier key, wherein the at least one sender device is configured to perform the following, after capturing an image:
encoding the image with one or more digital identifiers, thereby creating an encoded image,
creating one or more digital identifier keys of said encoded image as a function of the one or more digital identifiers,
creating auxiliary information, the auxiliary information including at least a share statement,
linking the auxiliary information to the one or more digital identifier keys, and
sending the one or more digital identifier keys and auxiliary information to the server system.

27. The system of claim 26, wherein at least the share statement of the auxiliary information is configured to be issued to a requester of an image sharing monitoring system for a service provider, in response to a user attempting to share the image with one or more other users through the service provider.

28. The system of claim 26, wherein the requester determines, based on the received share statement from the server system, whether the attempt of sharing the request image should be permitted or not.

29. The system of claim 26, wherein, if the image is shared two or more times, each shared image contains image-share-specific digital identifiers different from the other image-share-specific digital identifiers corresponding to the other shared images.

30. A system for decoding an encoded image before the encoded image is shared, wherein the encoded image has been previously encoded at an encoding module with one or more digital identifiers, the system comprising:
a decoding module configured to perform the following steps:
receive from a requester device the encoded image,
extract from the encoded image the one or more digital identifiers previously used to encode the image,
transmit the extracted one or more digital identifiers to a server system, such that the server system can do the following:
(1) search within a registry of the server system for auxiliary information linked to one or more digital identifier keys associated with the one or more digital identifiers of the encoded image,
(2) send to the requester device at least one of a share statement included in the auxiliary information linked to the one or more image-share-specific digital identifier keys and a message indicative of a content of the share statement.

31. The system of claim 30, wherein the decoding module is comprised in at least one sender device which acquired or retrieved the image before the image was encoded at an encoding module.
